(19) United States
(12) Patent Application Publication
(10) Pub. No.: US 2002/0125704 A1
(43) Pub. Date: Sep. 12, 2002

(54) Gas bag module

(75) Inventor: Ralf Heindl, Aschaffenburg-Obenau (DE)

Correspondence Address: TAROLLI, SUNDHEIM, COVELL, TUMMINO & SZABO L.L.P., 1111 LEADER BLDG., CLEVELAND, OH, 44114-1400, US

(73) Assignee: TRW Automotive Safety Systems GmbH & Co. KG

(21) Appl. No.: 10/090,393

(22) Filed: Mar. 4, 2002

(30) Foreign Application Priority Data
Mar. 8, 2001 (DE) 201 04 044.1

(51) Int. Cl. B60R 21/28

(52) U.S. Cl. 280/740

(57) ABSTRACT

The invention relates to a gas bag module comprising an accommodation housing for a gas bag, a gas generator and a cup-shaped diffusor which surrounds the gas generator and delimits an accommodation space for the gas bag. The diffusor has a radial flange by which it is fastened directly to the accommodation housing and which forms a ring-shaped base closing the accommodation housing. The diffusor projects into an interior of the accommodation housing and forms a gas generator space which is open from a base side of the diffusor.

### TECHNICAL FIELD

The invention relates to a gas bag module.

### BACKGROUND OF THE INVENTION

Known gas bag modules comprise an accommodation housing for a gas bag, a gas generator and a cup-shaped diffusor which surrounds the gas generator and delimits an accommodation space for the gas bag. Such gas bag modules are used in particular in the steering wheel of the vehicle. The diffusor delimits the radially inner side of a ring-shaped accommodation space for the gas bag, the radially outer side of the accommodation space being defined by a side wall of the accommodation housing. In prior art, a base plate is fastened to the accommodation housing, on which base plate the diffusor, the gas generator and a holding ring which is possibly arranged inside the gas bag, are fastened.

### BRIEF SUMMARY OF THE INVENTION

It is an object of the invention to provide a gas bag module which is more simply constructed and which permits, above all, a very simple installation.

This is achieved in a gas bag module which comprises an accommodation housing for a gas bag, a gas generator and a cup-shaped diffusor which surrounds the gas generator and delimits an accommodation space for the gas bag. The diffusor has a radial flange by which it is fastened directly to the accommodation housing and which forms a ring-shaped base closing the accommodation housing. The diffusor projects into an interior of the accommodation housing and forms a gas generator space which is open from a base side of the diffusor.

In the gas bag module proposed, the diffusor forms the base for the accommodation housing, so that the previously described base plate can be completely dispensed with. As thereby the diffusor also forms the closure of the accommodation housing, a gas generator space can be produced which is open from the side of the base, so that the gas generator at the end of installation can be introduced simply on the base side into the gas generator space, as it were as the last part to be installed. Hence it is also possible to ensure the desired separation, as long as possible, in handling of the gas generator and the remaining gas bag module.

The gas generator is introduced from the base side into the gas generator space and is fastened to the flange of the diffusor. The fastening from below provides a good accessibility for the fastening means. Further, the gas generator is completely arranged within the gas generator space.

According to an embodiment, the flange of the diffusor has an axial terminal edge which is bent, the diffusor being fastened to the side wall of the accommodation housing by means of this terminal edge. The accommodation housing therefore does not have to have a radially inwardly projecting section which forms a part of the base, which facilitates the production of the accommodation housing.

The accommodation housing preferably consists of a surrounding side wall and a front wall formed in one piece on the side wall, the front wall having a predefined opening flap for an emergence of the gas bag. The opening flap is formed in that the front wall has predefined tear-open lines with zones of weakened material. The gas bag module is therefore largely formed by only two parts which are simple to produce, namely the accommodation housing which is constructed in a cup shape, and the cup-shaped diffusor which is pushed in from the rear and the flange of which is fastened to the side wall of the accommodation housing.

The fastening of the gas bag on the gas bag module takes place, for example, by means of a holding ring arranged inside the gas bag, this ring being fastened to the flange of the diffusor. The holding ring then holds the edge of the so-called inflation opening, via which gas flows into the interior of the gas bag, on the gas bag module.

Preferably, the gas bag module is also equipped with a vibration damper by the gas generator being connected with its fastening flange via an elastomeric damping part. Inside the diffusor, the gas generator can then vibrate undisturbed, because it has a sufficient spacing from the diffusor.

### BRIEF DESCRIPTION OF THE DRAWING

FIG. 1 shows a schematic cross-section through a gas bag module according to the invention.

### DETAILED DESCRIPTION OF THE PREFERRED EMBODIMENT

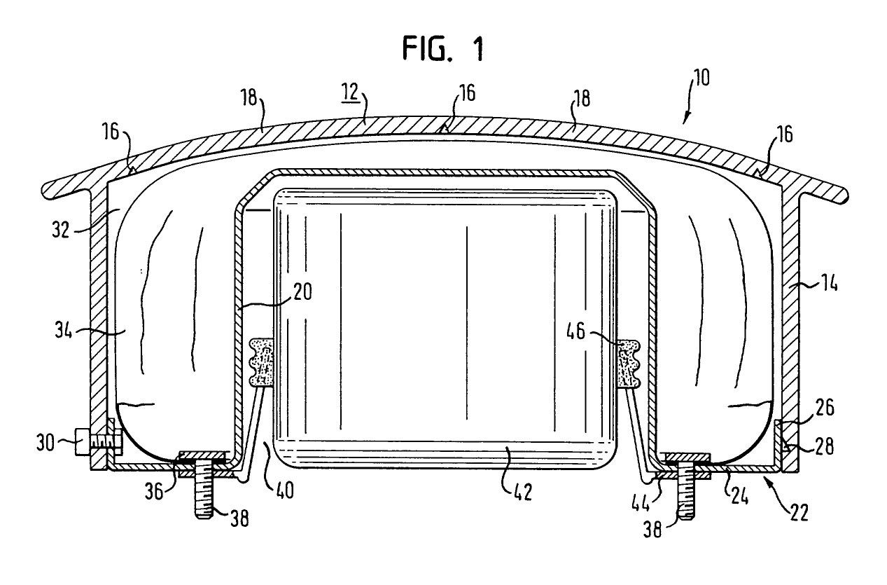

In FIG. 1 a gas bag module for a vehicle steering wheel is illustrated, which has a cup-shaped accommodation housing 10 with a front wall 12 and a surrounding side wall 14 formed in one piece thereon. The front wall 12 has several weakened zones 16 which define several opening flaps 18 which form sections of the front wall 12.

The gas bag module has, in addition, a cup-shaped diffusor 20 which is introduced from the open base side 22 of the accommodation housing 10 into the latter. The diffusor has at its end on the base side a radial flange 24 which extends outwards as far as to the side wall 14 and in this region has a bent terminal edge 26 extending in axial direction; at this terminal edge, the diffusor is firmly connected to the accommodation housing 10 via a detent connection 28 or a screw connection 30. The flange 24 terminates approximately flush with the lower edge of the side wall 14 and forms a ring-shaped base for closing the accommodation housing 10, because the diffusor 20 is open on the rear and therefore has an introduction opening for the gas generator 42. The diffusor is a sheet metal piece which has several through-flow openings and is spaced apart from the gas generator both in lateral and axial direction. Between the accommodation housing 10 and the diffusor 20, a closed-off space is formed, which is designated as a ring-shaped accommodation space 32 for a gas bag 34. Inside the gas bag 34, at the edge of the so-called inflation opening, a holding ring 36 is arranged, on which threaded bolts 38 can be attached that project on the rear face. The holding bolts 38 extend through openings in the flange 24.

Through the fact that the diffusor 20 is open on the base side, a gas generator space 40 is formed which is open on the base side. From this base side and at the end of the installation, a gas generator 42 is simply introduced into the gas generator space 40. The gas generator 40 has a cylindrical shape and a fastening flange 44 running initially in the direction to the base and then radially outwards. The fastening flange 44 is coupled with the gas generator 42 via an elastomeric damping piece 46, in order to accommodate the gas generator 42 in the gas generator space 40 in a neutralized manner with regard to vibration. On the base side, the fastening flange 44 lies directly against the flange 24, and the screw bolts 38 project through corresponding openings in the fastening flange 44.

The screw bolts 38 can also be used for fastening the entire module to the steering wheel.

The gas bag shown is constructed very simply and consists of very few parts which are easy to install. The stability of the accommodation housing is achieved by the diffusor 20, the flange 24 of which forms the base of the accommodation housing and closes it.

The gas bag module is axially very short in construction, because the gas generator 42 does not project on the base side beyond the accommodation housing.

1. A gas bag module, comprising
an accommodation housing for a gas bag,
a gas generator and
a cup-shaped diffusor which surrounds said gas generator and delimits an accommodation space for said gas bag,
said diffusor having a radial flange by which it is fastened directly to said accommodation housing and which forms a ring-shaped base closing said accommodation housing, and
said diffusor projecting into an interior of said accommodation housing and forming a gas generator space which is open from a base side of said diffusor.

2. The gas bag module according to claim 1, wherein said gas generator is introduced into said gas generator space from said base side and is fastened to said flange of said diffusor.

3. The gas bag module according to claim 1, wherein said flange of said diffusor has an axial terminal edge which is bent, said diffusor being fastened to a side wall of said accommodation housing by means of said terminal edge.

4. The gas bag module according to claim 1, wherein said accommodation housing consists of a surrounding side wall and a front wall formed in one piece on said side wall, said front wall having a predefined opening flap for an emergence of said gas bag.

5. The gas bag module according to claim 1, wherein said gas bag has a holding ring arranged in its interior and is fastened to said flange of said diffusor by means of said holding ring.

6. The gas bag module according to claim 1, wherein an elastomeric damping piece is provided by means of which said gas generator is connected with a fastening flange thereof, said fastening flange for its part being fastened to said flange of said diffusor.
